(19) United States
(12) Patent Application Publication
(10) Pub. No.: US 2009/0184650 A1
(43) Pub. Date: Jul. 23, 2009

(54) IGNITION CIRCUIT AND METHOD FOR A DISCHARGE LAMP

(75) Inventors: Johan Leopold Victorina Hendrix, Turnhout (BE); Dirk Jan Van Kaathoven, Eindhoven (NL); Marinus Jacobus Hendricus Roovers, Oss (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,578

(22) PCT Filed: Sep. 19, 2005
(86) PCT No.: PCT/IB05/53069

§ 371 Date: Mar. 20, 2007

(30) Foreign Application Priority Data
Sep. 27, 2004 (EP) 04104690.5

(51) Int. Cl. H05B 41/04

(52) U.S. Cl. 315/209 CD; 315/290

(57) ABSTRACT

An ignition circuit for generating high voltage pulses to a discharge lamp is provided with a switching element (SW1) to enable to stop generating said high voltage pulses when the lamp does not ignite or has ignited. The switching element (SW1) is connected between the input terminals (ground, Vdc) of a supply voltage and a parallel circuit of a capacitor (C1) and a series connection of a breakdown device (B1) and a primary winding (W1) of a transformer (T1). Switching the switching element (SW1) non-conductive prevents that the capacitor (C1) from charging.

The present invention relates to an ignition circuit for generating a high voltage pulse for igniting a discharge lamp, the circuit comprising a parallel circuit of a capacitor, and a series connection of a primary winding of a transformer and a breakdown device, input terminals connected to said parallel circuit for receiving a supply voltage; a secondary winding of said transformer being connectable to said discharge lamp.

The present invention further relates to a method for generating a high voltage pulse for igniting a discharge lamp, the method comprising supplying electrical power to a power storage device; and discharging said power storage device through a primary winding of a transformer, when a predetermined amount of power is stored in said power storage device, thereby generating said high voltage pulse in a secondary winding of said transformer.

For igniting a discharge lamp, in particular a high intensity gas discharge (HID) lamp, it is known to supply high voltage pulses to the lamp to establish a gas breakdown between the electrodes of the lamp. In a first type of a known electronic ignition circuit, high voltage ignition pulses are supplied to the lamp without further control. Such ignition circuits are commonly provided with a breakdown device such as a sidac or spark-gap. Such a breakdown device is a non-conducting element, if a voltage between a first and a second terminal thereof is below a breakdown voltage. When said voltage exceeds said breakdown voltage, the breakdown device becomes conductive. As soon as the voltage drops below said breakdown voltage again, the breakdown device becomes non-conducting again. A capacitor connected in parallel to said breakdown device is charged by a supply voltage until the voltage over the capacitor exceeds said breakdown voltage and the breakdown device becomes conductive. Then, the capacitor discharges through a primary winding of the transformer and the breakdown device, thereby generating a high voltage pulse in a secondary winding of said transformer. Said pulse is supplied to the discharge lamp. As soon as the capacitor is discharged, the breakdown device becomes non-conducting and the capacitor may be charged again.

When gas breakdown in the lamp occurs, i.e. the lamp has ignited and has become in an operative state, it is known to control the voltage for charging the capacitor to drop below the breakdown voltage of the breakdown device. Therefore, the breakdown device will not become conductive again and the ignition circuit stops generating the high voltage pulses. However, if the lamp does not ignite, the ignition circuit keeps generating said high voltage pulses.

In another type of ignition circuits, the circuit is controlled to time the generation of pulses and to stop generating the pulses if the lamp does not ignite. Thereto, a controllable breakdown device, such as an IGBT, is used. Due to the control of the breakdown device, the timing of the voltage pulses may be controlled. A further advantage of the controllable breakdown device is found in the fact that the supply voltage does not need to drop below a breakdown voltage to stop the ignition circuit when the lamp ignites. Disadvantageous is however that the controllable breakdown device is limited in voltage and current and it is a relatively expensive component.

It is an object of the present invention to provide an ignition circuit for generating a high voltage pulse, which ignition circuit may be controlled to stop generating said pulse.

The above object is achieved in an ignition circuit according to claim 1 and in a method for generating a high voltage pulse for igniting a discharge lamp according to claim 4.

The ignition circuit according to the present invention advantageously employs a switching element for preventing the capacitor from being charged. The switching element may be controlled to break the connection between the supply voltage and the capacitor. If the capacitor is not charged, the breakdown device will not become conductive, since the breakdown voltage is not reached. Thus, generation of the high voltage pulses is stopped.

Since the operation of the ignition circuit may be controlled to stop, the supply voltage does not need to drop below the breakdown voltage of the breakdown device, when the lamp has ignited. Thus, the supply voltage may be kept high and may thus advantageously be used for other parts of the ignition circuit or for operating the lamp after ignition, for example.

If the discharge lamp does not ignite, the control circuit may control the switching element to stop the ignition circuit. For example, if the lamp has not ignited after a predetermined period of time, it may be assumed that the lamp is broken and further energy may be preserved. Switching off the high voltage pulses if the lamp does not ignite also increases the safety. Also, the control circuit may be configured such that a user may switch off the ignition circuit. In an embodiment, the high voltage pulses may be generated in bursts, i.e. during predetermined periods of time, e.g. 15 seconds, and not be generated between said bursts, e.g. during 30 seconds, to limit the generated heat and thus limit stresses on components, thereby increasing their lifetime.

Since the ignition circuit is not provided with a controllable breakdown device as above described, such as an IGBT, but is provided with a breakdown device such as a spark-gap or sidac, the ignition circuit is suited to operate with high voltages and high currents. Such high voltages and/or currents are required for igniting certain known and future types of discharge lamps. Further, the ignition circuit according to the present invention is expected to be cheaper than an ignition circuit comprising an IGBT and thus possibly being a cost-effective alternative for such a circuit.

In an embodiment of the present invention the switching element is a transistor and the control circuit is connected to a control terminal of said transistor. A transistor is an electronic switching element. A conductive path between two terminals may be controlled to be conductive or non-conductive by applying a voltage to a third terminal, which may be indicated as a control terminal. In a further embodiment said transistor is a Field-Effect transistor (FET). The control circuit is then connected to the gate of said FET for controlling a conductive path between the drain and the source of said FET. However, in another embodiment, a bipolar transistor may as well be applied.

These and other aspects of the present invention will be apparent from and elucidated with reference to the embodiments described hereinafter.

The annexed drawings show non-limiting exemplary embodiments, wherein

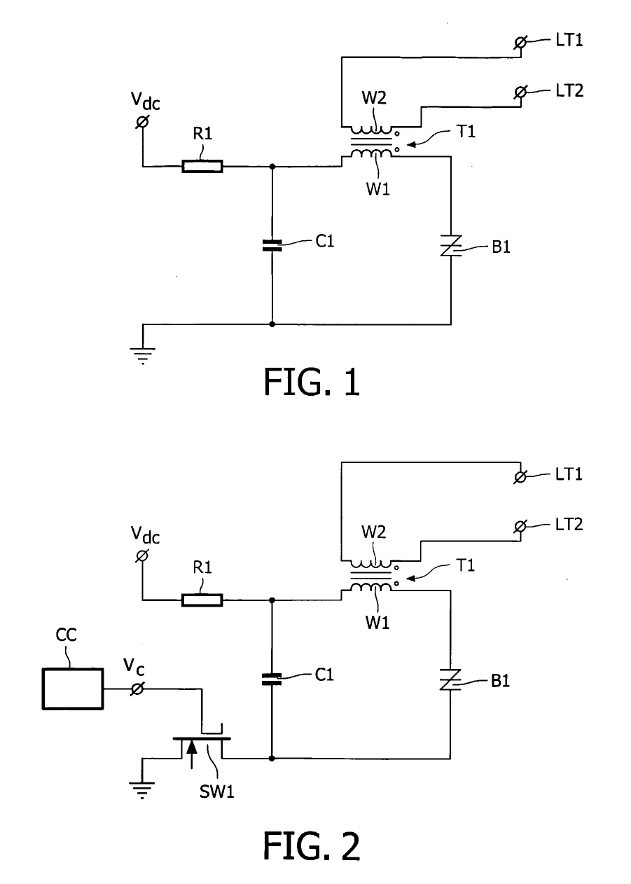

FIG. 1 schematically shows a prior art ignition circuit; and

FIG. 2 schematically shows an ignition circuit according to the present invention.

In the drawings, identical reference numerals indicate similar components or components with a similar function.

FIG. 1 shows a prior art ignition circuit as described above. Between ground and a supply terminal Vdc a DC supply voltage may be applied. Between ground and said supply terminal Vdc a parallel circuit of a capacitor C1 and a series connection of a primary winding W1 of a transformer T1 and a breakdown device B1 such as a Sidac or a Spark-gap is connected. Through a resistor R1 the capacitor C1 is charged. Due to the parallel connection with the capacitor C1, the voltage across the breakdown device B1 is equal to the voltage over the capacitor C1. While the capacitor C1 is charging, the voltage across the capacitor C1 increases. At first, the voltage across the parallel circuit is below a breakdown voltage of the breakdown device and hence, the breakdown device is non-conductive.

While the capacitor C1 is charging, the voltage across the capacitor C1 increases. As soon as the voltage across the capacitor C1 and across the breakdown device B1 exceeds the breakdown voltage, the breakdown device B1 becomes conductive. The capacitor C1 then starts to discharge through the breakdown device B1 and therefore also through the primary winding W1 of the transformer T1. Due to the current through the primary winding W1, a voltage is generated in a secondary winding W2 of said transformer T1. The value of said voltage depends inter alia on the ratio of the number of windings of the primary and the secondary winding W1, W2. Thus, a high voltage pulse may be generated over the secondary winding W2.

A gas discharge lamp may be connected between a first lamp terminal LT1 and a second lamp terminal LT2. The generated high voltage pulse is thus applied to the discharge lamp.

When the capacitor C1 is discharged, the voltage across the capacitor C1, and thus across the breakdown device B1, drops below the breakdown voltage. Therefore, the breakdown device B1 becomes non-conductive again, and the capacitor may start to charge again. The high voltage pulses are thus generated until the gas discharge lamp ignites.

When the lamp ignites, the supply voltage Vdc is controlled to drop below the above-mentioned breakdown voltage. For example, as known in the art, the supply voltage Vdc may be supplied from an open-circuit voltage, which is also supplied to the lamp. The high voltage pulses are then superposed on said open-circuit voltage. However, when the lamp ignites, the open-circuit voltage drops. Therefore, the capacitor C1 is not able to charge again to a level above the breakdown voltage and the breakdown device B1 cannot become conductive again.

FIG. 2 shows an ignition circuit according to the present invention in which a switching element SW1 is added compared to the circuit illustrated in FIG. 1. The switching element SW1 is connected between the parallel circuit of the capacitor C1 and the series connection of the breakdown device B1 and the primary winding W1. The switching element SW1 may be controlled by applying a control voltage to a control terminal Vc.

In FIG. 2 a FET is illustrated as the switching element SW1, by way of example. The control terminal Vc is connected to a gate of the FET and a source and drain of said FET are connected between ground and said parallel circuit. For igniting a discharge lamp connected between lamp terminals LT1 and LT2 a suitable voltage is applied to the control terminal Vc such that the path between the source and the drain is conductive. Thus, the process of charging and discharging of the capacitor and thereby generating a high voltage pulse over the secondary winding W2 may be performed by supplying a supply voltage between ground and the supply terminal Vdc.

The circuit illustrated in FIG. 2 is thus suitable for performing the method according to the present invention, in particular by supplying electrical power to the capacitor C1, thereby increasing a voltage over the breakdown device B1. Then, said capacitor C1 is discharged through the primary winding W1 of the transformer T1, when a predetermined amount of power is stored in said capacitor C1. When said predetermined amount of energy is stored in said capacitor C1, a predetermined breakdown voltage is exceeded, causing the breakdown device B1 to become conductive. By discharging the capacitor C1 through the primary winding W1, said high voltage pulse is generated in the secondary winding W2 of said transformer T1.

When the ignition circuit may stop generating high voltage pulses, for example if the lamp does not ignite within a certain period of time or the lamp has ignited, the switching element SW1 may be controlled to become non-conductive, thereby interrupting a supply of electrical power to said capacitor C1. Thus, when the switching element SW1 is non-conductive, the capacitor C1 cannot charge and no pulses are generated.

A control circuit cc is connected to said control terminal Vc. The control circuit cc may determine when to switch off the ignition circuit, for example after a predetermined period of time, in response to a user input, or after the lamp has ignited, which is detected in a manner known per se.

Since the supply voltage does not need to drop below the predetermined breakdown voltage when the lamp has ignited, the supply voltage may be a higher voltage and/or may be kept high enabling to use the supply voltage also for other parts and/or after ignition of the lamp.

As mentioned above, the ignition circuit according to the present invention is a cost-effective circuit suitable for high voltages and currents.

In the above description as well as in the appended claims, ‘comprising’ is to be understood as not excluding other elements or steps and ‘a’ or ‘an’ does not exclude a plurality. Further, any reference signs in the claims shall not be construed as limiting the scope of the invention.

1. Ignition circuit for generating a high voltage pulse for igniting a discharge lamp, the circuit comprising a parallel circuit of
a capacitor (C1), and
a series connection of a primary winding (W1) of a transformer (T1) and a breakdown device (B1),
input terminals (ground, Vdc) connected to said parallel circuit for receiving a supply voltage; a secondary winding (W2) of said transformer (T1) being connectable to said discharge lamp, characterized in that the ignition circuit further comprises a controllable switching element (SW1) between one of said input terminals (Vdc, ground) and said capacitor (C1), and further comprises a control circuit for controlling said switching element (SW1).

2. Ignition circuit according to claim 1, wherein the switching element is a transistor and the control circuit is connected to a control terminal of said transistor.

3. Ignition circuit according to claim 2, wherein said transistor is a field effect transistor (FET) and said control circuit is connected to a gate of said FET.

4. Method for generating a high voltage pulse for igniting a discharge lamp, the method comprising:
supplying electrical power to a power storage device; and
discharging said power storage device through a primary winding of a transformer, when a predetermined amount of power is stored in said power storage device, thereby generating said high voltage pulse in a secondary winding of said transformer;
characterized by
interrupting the supply of electrical power to said power storage device in order to immediately stop generating said high voltage pulse.
